(19) United States
(12) Patent Application Publication
(10) Pub. No.: US 2009/0308345 A1
(43) Pub. Date: Dec. 17, 2009

(54) Energy Converter Having Pistons with Internal Gas Passages

(75) Inventor: Anthonie Van den Brink, Westmaas (NL)

Correspondence Address: THE WEBB LAW FIRM, P.C., 700 KOPPERS BUILDING, 436 SEVENTH AVENUE, PITTSBURGH, PA, 15219, US

(73) Assignee: Stichting Administratiekantoor Brinks Westmaas, Westmaas (NL)

(21) Appl. No.: 12/298,460

(22) PCT Filed: Apr. 19, 2007
(86) PCT No.: PCT/NL07/50160

§ 371 Date: Feb. 2, 2009

(30) Foreign Application Priority Data
Apr. 27, 2006 (EP) 06113223.9

(51) Int. Cl. F02B 75/32; F01B 31/00

(52) U.S. Cl. 123/197.1; 92/181 P

(57) ABSTRACT

The invention relates to an energy converter including a combustion cylinder having a valve that, as part of a valve/piston assembly, transfers the forces generated in the combustion chamber to an electrical linear actuator, and a sealingly engaged piston that by its motion relative to the valve opens and closes a port.

The invention relates to a energy converter comprising a combustion cylinder, a power coil attached to a reciprocating piston and a substantially stationary field coil. The invention in particular relates to an energy converter comprising a combustion cylinder having a cylinder wall with at a first end a first gas passage, a piston having a piston outer body being reciprocally mounted in the cylinder along a longitudinal axis, the piston sealingly engaging with the cylinder wall and having a top surface extending substantially transversely to the cylinder wall and a side surface extending in the direction of the longitudinal axis, an internal gas passage being situated in the top surface, the internal gas passage being closable by a closure body that is connected to a valve stem which slidably extends in the piston, away from the top surface of the piston, the valve stem being connected to a spring member for forcing the closure body and the internal gas passage towards one another,

a second gas passage being provided in the cylinder wall near a second end of the cylinder wall

A linear free piston internal combustion generator is known from international patent application no. PCT/NL2005/000696 in the name of the applicant. In the known generator, the power coil is driven by a combustion cylinder having a configuration with the inlet and outlet ports both located on one end of the cylinder, opposing the piston.

Also in previous free piston designs the control of the inlet and exhaust has been achieved mostly by piston controlled ports, but also by externally positioned activated valves. Virtual all free piston (FP) designs have been for 2 stroke engines to keep the design and control simple. But such concepts have sincere limitations in terms of efficiency, emissions and control.

In configurations with the inlet and outlet ports both located on one end of the cylinder, such as also exists in most 4-stroke FP and conventional rotating engines, the flow of the gases is restricted in view of the limited diameter of the 2, 3 or 4 circular valve ports in the circular piston area and the inflow and outflow of gasses occurring in opposite directions such that the scavenging effectiveness is reduced.

To activate their valves external mechanical and/or electromechanical mechanisms are necessary, requiring many costly components, much space and operational energy. Also for a balanced motion, more than one cylinder is required thus multiplying these drawbacks for each extra cylinder.

Furthermore, in conventional rotating engines the compression ratio, the lengths of the cycle strokes are fixed and dictated by the mechanical construction. Stroke lengths of the conventional cylinders can only be varied by complicated and hence expensive mechanisms, in order to obtain optimum thermodynamic cycles.

This all places a limit on reducing fuel consumption and generates high manufacturing costs.

From U.S. Pat. No. 5,775,273 a free piston internal combustion engine is shown, having an inlet valve that is part of the reciprocating piston, which is controlled via gas pressure applied and released from a high gas pressure reservoir under computer control. Such an external valve control mechanism is relatively complex and requires a gas control port through extending through the reciprocating piston body and selectively connecting to a gas passage in the cylinder wall.

It is therefore an object of the present invention to provide a energy converter which can have relatively large inlet and outlet ports and simple activating mechanisms, which allows accurate valve control and which is easily balanced even with only one combustion chamber.

It is also an objective of the present invention to provide a linear free piston generator of the above-mentioned type which has a increased power output at a reduced weight, and which has design and operational freedoms to allow different thermodynamic cycles, such as for instance an Atkinson-like cycle.

Hereto the energy converter according to the present invention comprises the piston outer body is connected to a magnetic field element that is coaxial with the cylinder, a substantially stationary control coil being provided around the magnetic field element for providing an axial force on the piston, the valve stem extending slidably trough a outer surface of the piston, which outer surface is situated at a distance from the top surface and which extends transversely to the cylinder wall, an electrical power generating member being attached to valve stem part extending outside the piston.

Due to the absence of a crank/piston rod system in free piston engines, there is no more major hindrance to situate the inlet and/or outlet valves in the piston. This way this invention was able to open a new approach engine design by including the port opening mechanisms in the piston, for instance activated by controlled magnetic forces. Thus a magnetic pull in combination with kinetic energy of the piston can be used to open the valves (better called sleeves, since it is a design whereby the piston sleeves, instead of the valves, are moved relative to the power transferring part of the piston assembly to open or close the ports).

No external valve control mechanisms are needed. Only two extra impulse-activated electric coils are added. This design is suitable for both a 2 stroke as well as a 4-stroke cycles. Flexibility in the timing of these electrically controlled ports, unrestricted by mechanical restraints, in combination with the potential of also changing the compression ratio dynamically, allows maximum optimisation of the engine to achieve high thermodynamic efficiencies.

In a preferred embodiment, the energy converter of the present invention comprises two coaxially placed pistons situated in the cylinder, the pistons each closing off an end face of a common combustion chamber in the cylinder.

Hereto a energy converter in accordance with the invention comprises two opposing pistons reciprocally mounted in the cylinder along a longitudinal axis, the pistons sealingly engaging with the cylinder wall, having top surfaces extending substantially transversely to the cylinder wall and side surfaces extending in the direction of the longitudinal axis, magnetic sleeve being attached to the piston side surfaces, coaxially with the cylinder, substantially stationary impulse control coils being situated around the piston side surfaces, coaxially with the magnetic sleeve, internal gas passages being situated in the top surfaces of the pistons, the internal gas passages being closable by closure bodies that are connected to valve stems which extend in the cylinder, away from the top face of the pistons, the valve stems being connected to frames for moving power coils coaxially with stationary field coils, the closure bodies moveable either downwards (inlet side) or upwards (exhaust side) relative to the piston top surfaces, second external gas passages being provided in the cylinder wall at or near the second end of the cylinder wall.

In a further embodiment, each piston sleeve is coupled to the reciprocating valve stem via a mechanical spring or gas spring providing a closing force on the engagement. For actuation of the valves at high frequencies, such as 10-100 Hz or more, it is favourable to attach the valve stems to a gas spring, for instance of the type as disclosed in PCT/NL2005/000696 filed in the name of the applicant. To reduce seal friction losses and to have nearly equal forces on both sides of the gas spring the gasspring is preferably connected to the valve head via a valve stem of a minimum diameter.

To overcome control problem in free piston systems we have introduced such gas springs that are pressurised and dimensioned to be able to store a large amount of energy in the oscillating system, such that the energy flux from the ICE to the generator is a fraction of this energy in the oscillating system thus stabilising the engine. Thereby it also creates virtual constant travel strokes and end positions. Thus it can be compared with the effect of the flywheel in a rotating ICE.

By starting the engine not from the ICE power side but by using the linear generator as start motor the oscillation can be brought to well controlled amplitudes and speeds such that the combustion can be started. Since thus refined control of the oscillation frequency becomes feasible it is possible to make an arrangement of two opposing pistons forming the combustion chamber with a fully balanced synchronisation.

For actuation of the valves at such high oscillating frequencies, resulting in large acceleration forces and under the high pressures of the thermodynamic cycle, it is favourable to hold the piston outer embodiment with its spring closing element against the valve closure body, by means of a gas spring instead of mechanical springs, since high forces are required leading to heavy mechanical spring designs. The pressure necessary, to achieve the right closing and opening function, can be provided from the gas springs through capillary channels, via the valve stem.

Also the piston top surface, at least near the internal gas passage, is provided with a spring closing element for a flexible contact to the closure body. Thus at high speeds, the impact of the returning piston sleeve closure member is absorbed by the spring element around the valve opening.

Thus a compact, low cost energy converter can be constructed with many functional advantages:

With the use of high speed processing systems, providing accurately timed magnetic impulses, fast accurate and variable control of the port timing is possible, by creating time-controlled travel of the outer piston sleeves, relative to the central valves with their closure bodies, without the need for complicated mechanical structures.

Since full balancing, with two pistons, is thus achieved, without rest forces or torque's, only one cylinder is required for most applications

Since only one port needs to exist per piston, maximum port openings are possible.

In the present invention, delaying of the inlet valve opening and/or matching the outlet ports, various thermodynamic cycles can be obtained.

The linear energy converter design of the present invention can be used both for a 2-stroke and for a 4-stroke engine.

The generator of the present invention can be applied to spark ignition (SI) engines as to direct injection (DI) engines, and with various fuels; such as for instance low CO₂ bio-diesel.

The compression ratio can be varied relatively easily.

The absence of a vulnerable piston, connecting rod, and crankshaft construction allows higher pressures and greater reliability at lower weights, thus increasing the specific output of the generator.

A part of the deceleration energy of the piston sleeves can be recovered by the electrical system by storing such energy in accumulators such as capacitors and releasing the same during the opposite travel and/or can be used to assist the opening and closing motions of the ports.

In the energy converter of the present invention, with its single cylinder, a full balance of forces is possible, thus reducing mechanical friction, size and manufacturing costs.

It is also possible to apply this design to single piston operation with for instance a conventional electric valve controlled exhaust port in the fixed side.

For improving the intake gas loading in the combustion chamber it is possible to use for instance turbine systems driven by the exhaust gases or to use the pressure fluctuations within the enclosure of the generator section.

When using the generator as a motor the port controls can be programmed such that the energy converter operates as a pump.

The combustion generator may be used in automotive propulsion, for instance in small mid-size and large hybrid vehicles feeding its electrical power to an electric drive motor, or can be used in a stationary applications for generation of electrical power.

Some embodiments of a energy converter according to the present invention will be explained in detail, with reference to the accompanying drawings. In the drawings:

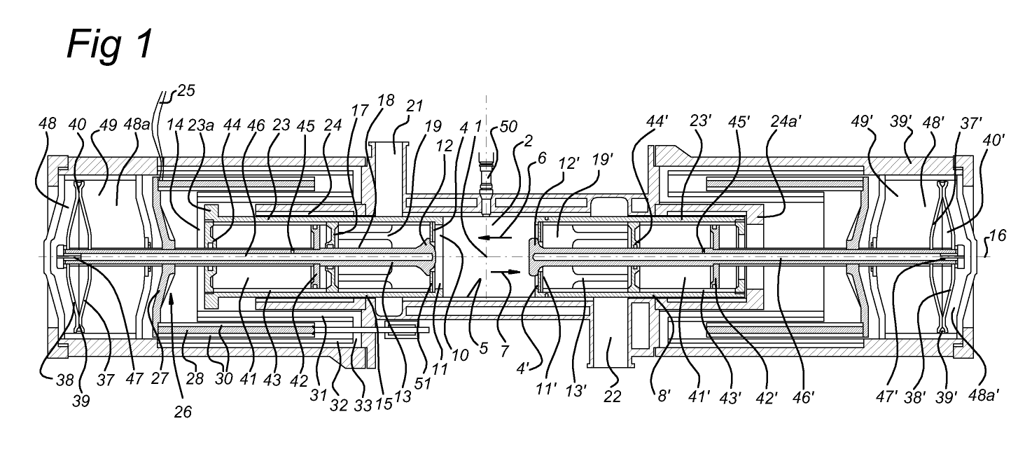

FIG. 1 shows a cross-sectional view of a free piston energy converter according to the invention comprising two opposed co-axial pistons, and

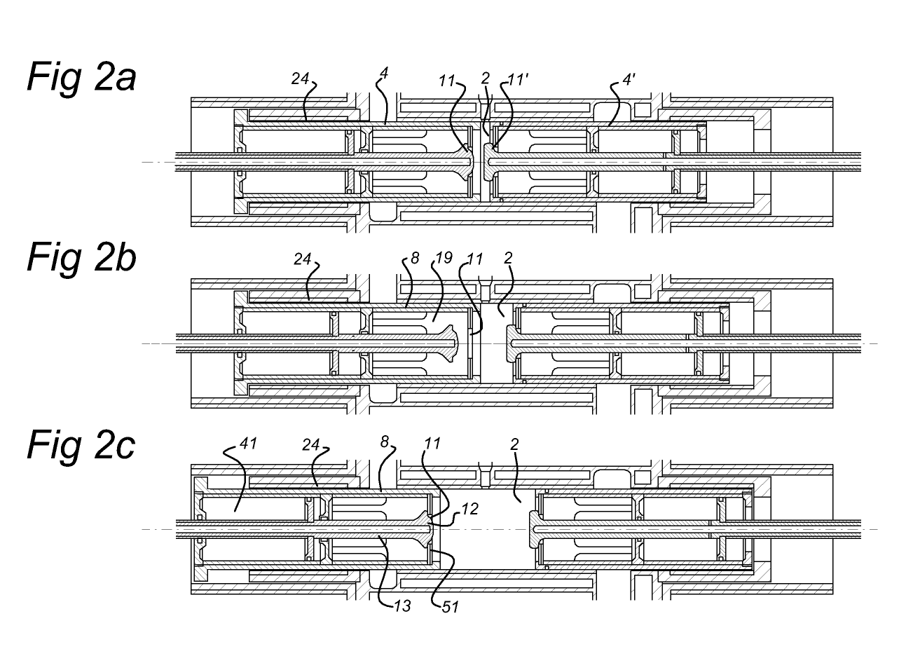

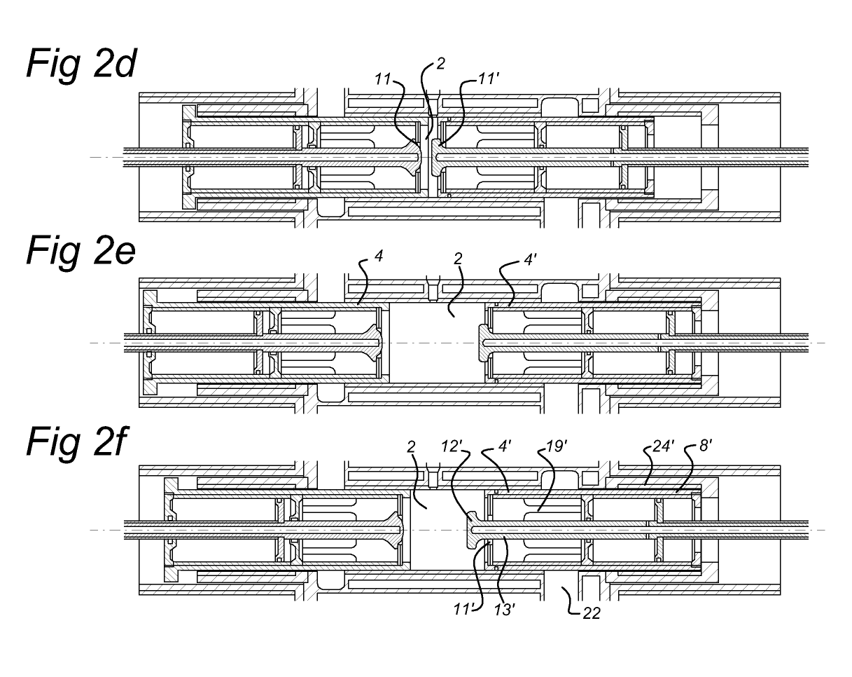

FIGS. 2a-2f show a functional cycle of the present energy converter in a four stroke action.

FIG. 1 shows a linear free piston energy converter 1 in outer dead point position (ODP) according to the present invention comprising a single combustion cylinder 2 and two coaxial pistons 4,4′. The piston 4 is in a top surface 10 provided with an internal gas passage or inlet opening 11, which is closed by a closure body 12 of a valve 13. The piston 4 comprises a side surface 15 extending in the direction of a longitudinal axis 16 of the generator 1. An upper compartment 19 of the hollow piston 4 is defined by a bottom wall 17 which sealingly engages with a valve stem 18 of the valve 13. The upper compartment 19 communicates with an inlet port 21 via which air or a fuel-air mixture is supplied to the compartment 19. A similar compartment 19′ in hollow piston 4′communicates with an exhaust outlet port 22.

The part of the side surface 15 of the piston 4 which extends outside the combustion part of the cylinder 2 supports and is rigidly connected with a magnetic sleeve 23 with a magnetic flange 23a. Coaxially with the magnetic sleeve 23, a stationary magnetic field coil 24 is provided surrounding the piston 4. The stationary magnetic field coil 24 is connected to a control device for selective timing the magnetic force generated by the stationary magnetic field coil 24 for exerting a longitudinal force on the magnetic piston sleeve 23. The field coil 24 is connected to an electric control unit for providing electric impulses in time for opening and closing the inlet ports. The magnetic pull on the piston sleeve 23 is maximum when the piston 4 is in the inner dead point IDP. The port of the piston 4′ is activated similarly with the difference that the magnetic flange 24a′ is located on the stationary coil frame and that the magnetic pull on piston sleeve 23′ is maximum when the piston 4′ is in the outer dead point ODP.

In order to provide an optimal pulling force on in the pistons 4,4′, the end parts 23a, 24a′ in the closest position are situated opposite the static magnetic core at a short distance, to effectively guide the magnetic flux lines into the metal of the pistons 4,4′.

The valve stem 18 of the valve 13 extends beyond the piston end surface 14, and is provided with a first frame 26, having a first frame part 27 extending transversely to the longitudinal axis 16, and a second frame part 28 extending in the direction of the longitudinal axis 16. The second frame part 28 carries a power coil 30, which is coaxial with stationary field coils 31,32 that are supported on a second frame 33.

The power coil 30 is connected to a control device for selective coupling the output of the coil to an electric accumulator or directly to an electric drive motor. A power outlet for electrical power is schematically indicated at 25. The field coils 31,32 are connected to an electric control unit for providing a varying frequency driving voltage to the field coil. The control units for the coils 31,32 have not been indicated in the drawings and may be executed in the manner that is described in the co pending international patent application number PCT/NL2005/00696 in the name of the applicant.

Within the lower part of the hollow piston 4, a gas spring chamber 41 consists of an upper wall 42 rigidly connected to the valve stem and sealingly engaged to the inner wall 43 of the lower section of the piston and a lower wall 44 as part of the piston 4 and sealingly engaged to the valve stem, whereby the gas spring chamber 41 may be connected to the gas spring chambers 48, 48a through micro pore channels 45, 46, 47. This results in a non-varying pressure in the gas spring chamber 41 at virtually the average of the prevailing pressures in chambers 48, 48a of the gas spring 49, thus providing a return force on the piston.

Within the lower part of the hollow piston 4′, a gas spring chamber 41′ consists of an lower wall 42′ rigidly connected to the valve stem and sealingly engaged to the inner wall 43′ of the lower section of the piston and a upper wall 44′ as part of the piston and sealingly engaged to the valve stem, whereby the gas spring chamber 41′ may be connected to the gas spring chambers 48′ of the gas springs 49′ through micro-pore channels 45′, 46′, 47′. This results in a non-varying pressure in the gas spring chamber 41′ at virtually the average of the prevailing pressures in chambers 48′, 48a′ of the gas spring 49′, thus providing a return force on the piston.

The piston 40, 40′ in the gas-filled chambers 48/48a, 48′,48′a of the gas spring chambers 49, 49′ are formed by saucer-shaped plates 37,38 and 37′,38′ mutually connected via a sealing rims 39, 39′.

In the case of a DI injection engine, the fuel is injected into the combustion chamber 2 by an injector 50. The exhaust gases are removed by opening of the port 11′, via the compartment 19′ of hollow piston 4′, via outlet port 22. After expulsion of the exhaust gases from the combustion chamber 2, a new load of air-fuel mixture is admitted via inlet port 21 and compartment 19, by opening of the port 11.

In FIGS. 2a-2f a four-stroke cycle of the pistons 4,4′ inside the combustion cylinder 2 is shown.

In FIG. 2a the ports 11,11′ are in their closed position at the inner dead point (IDP) position.

In FIG. 2b, the piston assemblies 4, 4′ are drawn outwardly, thereby holding piston outer body 8 in the IDP by energising the stationary magnetic field coil 24. Thus the air-fuel mixture is admitted in the combustion chamber from compartment 19 via the internal gas passage 11.

In FIG. 2c it is shown that the valve 13 and piston 4 are moved further outwardly, meanwhile the energising the stationary magnetic field coil 24 is stopped and the pressure force of the gas spring chamber 41 moves the piston outer body 8 to catch up with the valve closure body 12 such that the inlet port 11 is closed. The impact of the closure is absorbed by the spring elements 51 around the valve opening. The disc shaped spring element 51 of the inlet side seals the valve closure body on the upper side of the valve flange and the disc shaped spring element 51′ of the exhaust side seals the valve closure body 12 on the lower side of the valve flange.

In FIG. 2d after compression the pistons are at the inner dead point (IDP) position of FIG. 2a and the ports 11 and 11′ are in their closed position. The air-fuel mixture inside the cylinder 2 is ignited.

As shown in FIG. 2e the pistons 4,4′ are driven outwardly by the expanding combustion gases to the position.

In FIG. 2f, it is shown that the piston outer body 8′ is held backwardly by the energised field coils 24′, such that the closure body 12′ of valve 13′ is moved away from the internal gas passage 11′ and combustion gases can flow from the compartment 19′ in the hollow piston 4′ to the outlet port 22.

Hereafter, the pistons 4,4′are moved together to the inner dead point position and the exhaust port closed as shown in FIG. 2a, after which the cycle is repeated.

The valve seats of the internal gas passages 11,11′ are formed by disc-shaped spring elements 51, made from a resilient material, in order to withstand the high impact speeds of the valve closure body 12 at high temperatures.

Even though the invention has been described by way of example in the above embodiments, in relation to two coaxial pistons 4,4′, the invention can equally as well be applied to a linear piston energy converter having a single piston.

1-10. (canceled)

11. An energy converter comprising a combustion cylinder having a cylinder wall with at a first end, a gas passage, a piston being reciprocally mounted in the cylinder along a longitudinal axis, the piston sealingly engaging with the cylinder wall and having a top surface extending substantially transversely to the cylinder wall and a side surface extending in the direction of the longitudinal axis, the top surface and the side surface defining an internal compartment communicating with the gas passage, an opening being situated in the top surface and being closeable by a closure body that is connected to a valve stem which slidably extends in the piston, and a power generating member being driven by the valve stem part extending outside the piston.

12. The energy converter according to claim 11, comprising two coaxially placed opposing pistons situated in the cylinder, the pistons each closing off an end face of a common combustion chamber in the cylinder.

13. The energy converter according to claim 11, wherein the power generating member comprises a linear actuator

14. The energy converter according to claim 11, wherein the valve stem extends slidably through an outer surface of the piston, which outer surface is situated at a distance from the top surface and which extends transversely to the cylinder wall.

15. The energy converter according to claim 11, the piston having an outer body connected to a magnetic field element that is coaxial with the cylinder, a substantially stationary control coil being provided around the magnetic field element for providing an axial force on the piston.

16. The energy converter according to claim 11, the valve stem being attached to a first frame carrying a valve actuator coil, which is situated coaxially with a second, stationary frame carrying a valve field coil.

17. The energy converter according to claim 11, wherein the piston top surface at least near the internal gas passage is provided with a spring closing element for contacting the closure body.

18. The energy converter according to claim 11, the valve stem being attached to a gas spring.

19. The energy converter according to claim 18, wherein a second piston is attached to the valve stem, closing off a gas pressure chamber situated near a free valve stem end, which gas pressure chamber is connected via a channel in the valve stem with a chamber of the gas spring.

20. The energy converter according to claim 11, the valve stem being provided with an abutment member acting against a spring which is on one side affixed to the piston for pressing the closure body against the piston top surface.

21. The energy converter according to claim 12, wherein the opening in the piston opens when the piston moves upward relative to the closing member and wherein an opening in the other piston opens when the other piston moves downward relative to another closing member.

22. The energy converter according to claim 15, wherein the magnetic engagement of coil and magnetic field element with a flange is in its closest position when the piston is in an inner dead point IDP and wherein the magnetic engagement of another coil with a flange and another magnetic field element is in its closest position when another piston is in its outer dead point ODP.
